(19) United States
(12) Patent Application Publication
(10) Pub. No.: US 2012/0119421 A1
(43) Pub. Date: May 17, 2012

(54) DEVICE AND METHOD FOR PROCESSING THE EMBOSSING STRUCTURE OF 3-LAYER CO-EXTRUDED BIAXIAL ORIENTED POLYPROPYLENE (BOPP) PEARL SYNTHETIC PAPER

(76) Inventors: Allen F. C. LIN, Taipei County (TW); Hong Kuo Cheng, Taipei County (TW)

(21) Appl. No.: 12/945,981

(22) Filed: Nov. 15, 2010

(51) Int. Cl. B29C 59/04; B29C 35/10

(52) U.S. Cl. 264/481; 264/293; 425/174.4

(57) ABSTRACT

The present invention discloses a device and a method for processing the impression structure of 3-layer co-extruded biaxial oriented polypropylene (BOPP) pearl synthetic paper. The depth of the impression on the synthetic paper is between 0.2-1000 μm which is embossed by the modified embosser. The 3-layer co-extruded pearl synthetic paper is processed for cooling, biaxial orientation, corona treatment and winding and then passing through the modified embosser to preheating, calender, cooling. The modified embossing device comprises a rubber back-up roll having at least Shore A hardness of 60-90; an embossing roll with a designed pattern and a cooling system having a core; a quartz electric heating oven preheated to 65° C. to 160° C.; a infrared heater; and two adjacent cooling drums with 7° C.

### FIELD OF THE INVENTION

The present invention generally relates a device for processing the impression structure of 3-layer co-extruded biaxial oriented polypropylene (BOPP) pearl synthetic paper. The impressing texture is produced by the modified embosser, which includes at least one rubber back-up roll having Shore A hardness of 60-90; the weight of synthetic paper is 20 g/m²-210 g/m², the preheating temperature is 65° C.-160° C. and the impression is processed at less than 160° C. The synthetic paper possesses certain roughness and specific impression whereby to be advantageous in the paper sheet feeding to the printer or it can substitute the canvas or the art paper.

### DESCRIPTION OF THE PRIOR ART

U.S. Pat. No. 5,536,468 of Jul. 16, 1996 to Arjobex Co. discloses a method of making watermarks on a polymeric paper. The method is to pass a polymeric sheet between two rollers in abutment with each other, wherein at least one of the rollers having a recessed and/or raised motif to form an impression on the passing sheet which impression corresponds to the recessed and/or raised motifs on said roller(s), and the sheet is oriented by stretching the sheet. The impressed and oriented sheet has dark areas corresponding to the raised portions and light areas corresponding to recessed portion of the motif. It is impression technology of a single polymeric sheet.

U.S. Pat. No. 6,364,988 B1 of Apr. 2, 2002 to Nan Ya Plastics Co. discloses a 3-layer co-extruded biaxially oriented polypropylene synthetic paper produced by means of 3-layer co-extrusion, wherein a polypropylene resin and a inorganic compositions separately extruded by a twin screw primary extruder and two twin screw secondary extruders are co-flowed by a same T-die to form a three layers coating sheet with paper sheet layer and resin foamed intermediate layer/paper sheet layer or resin layer. Furthermore, cooling, biaxial orientation, corona treatment and winding to form a 3-layer co-extrusion synthetic paper.

The 3-layer co-extrusion synthetic paper disclosed in U.S. Pat. No. 6,364,988 B1 is substituted the paper made of natural paper pulp and it could be use to write, print, package and other kinds of application. According to the 3-layer structure of synthetic paper of Japanese Patent Nos. 46-040794B(1971), 56-118437A(1981), 56-141339A(1981), and 03-087255A(1991), these paper are unlike the single layer sheet of the U.S. Pat. No. 6,364,988 patent which is easy to have impression and become a water marks product.

In order to overcome the difficulty of producing the impression on the 3-layer synthetic paper, the applicant has researched for a long time and discovered that the back-up roll of embosser is modified to be a rubber back-up roll with Shore A hardness of 60-90 and the 3-layer structure paper is preheated at 65-160° C., and then the speed of 3-layer structure paper passed through the back-up roll, the embossing roll and the cooling drum are controlled between 15-18 meters per minute. The cooling drum keeps at 7° C. Thus, the embossed synthetic paper is able to obtain the satisfied result same as the canvas or the art paper so that it can substitute them.

### SUMMARY OF THE INVENTION

The impressing structure of 3-layer co-extruded biaxial oriented polypropylene (BOPP) pearl synthetic paper of the present invention is produced by the modified embossing device. The weight range of synthetic paper for processing is 20 g/m²-210 g/m² and the synthetic paper becomes certain roughness to facilitate sheet-fed or as substitutive of canvas or art paper. The modified embosser includes at least one rubber back-up roll having Shore A hardness of 60-90, a quartz electric heating oven and a infrared heater preheated to 65° C. to 160° C. and embossed, and two adjacent cooling drums with 7° C.

The device for processing the impressing structure of 3-layer co-extruded biaxial oriented polypropylene pearl synthetic paper of the present invention is to preheat the synthetic paper at the 65-160° C. Then, the synthetic paper is embossed by passing through the rubber back-up roll having at least Shore A hardness of 60-90 and the embossing roll having impression patterns and the embossing roll and the back-up roll are cooled synchronously. Finally, the synthetic paper is cooling by the cooling drum keeping at 7° C.

According to the device for processing the impressing structure of 3-layer co-extruded biaxial oriented polypropylene pearl synthetic paper of the present invention, the depth of the impression on the synthetic paper is between 0.2-1000 μm.

According to the device for processing the impressing structure of 3-layer co-extruded biaxial oriented polypropylene pearl synthetic paper of the present invention, the preheating process is to heat the both side of synthetic paper by sectional heater and then the synthetic paper is impressed by passing through the embossing roll and the back-up roll having at least Shore A hardness of 60-90. The impressing structure of synthetic paper is shown in FIG. 1.

### BRIEF DESCRIPTION OF THE DRAWINGS

FIG. 1 illustrates a diagram of the impressing structure of pearl synthetic paper in accordance with the present invention;

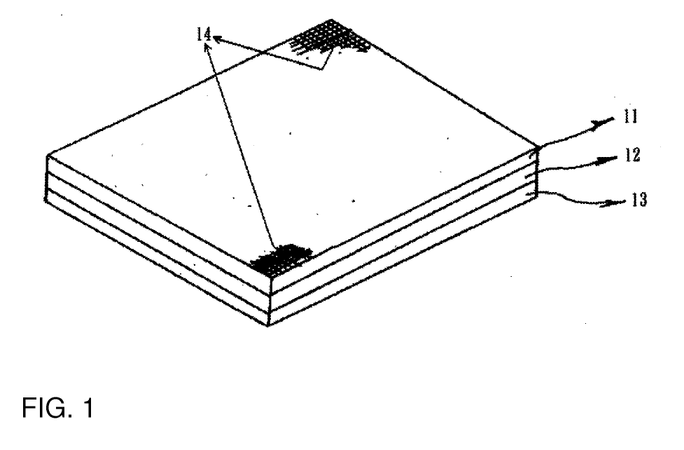

FIG. 2 illustrates a diagram of the process for manufacturing the biaxial oriented polypropylene pearl synthetic paper in accordance with the present invention;

FIG. 3 illustrates a diagram of the device for processing the impressing structure of pearl synthetic paper in accordance with the present invention.

### DESCRIPTION OF THE PREFERRED EMBODIMENT

According to the present invention, the above mentioned 3-layer co-extruded biaxial oriented polypropylene pearl synthetic paper is a base substrate to be impressed any demanded impression patterns. The synthetic paper is passed through the modified device for processing the impressing texture. To choose the weight of pearl synthetic paper between 20 g and 210 g per square meters and to apply the means of heating and impressing on the pearl synthetic paper. Thus, the pearl synthetic paper of present invention could form a certain roughness to be contributive in feeding the paper sheet to the printer, or could process to be an imitating canvas product, which is produced by the modified embosser with EPDM (Ethylene-Propylene-Diene Monomer) rubber back-up roll having Shore A hardness of 60-90.

According to the impression device of the present invention, the synthetic paper is preheated to about 65° C. to 160° C. at first. Before passing through the embossing roll and the back-up roll with special hardness, the synthetic paper is heated by an infrared heater to less than 160° C., which is the melting point of polypropylene. After passing through the embossing roll and the back-up roll with special hardness, the synthetic paper with impression is passed through cooling drum at 7° C. rapidly to be cooled.

The 3-layer co-extruded biaxial oriented polypropylene pearl synthetic paper is 3-layer structure, for example, mist paper sheet layer/foam intermediate layer/adhesive layer or glare paper sheet layer/foam intermediate layer/adhesive layer, or resin layer/resin layer/adhesive layer, wherein the material of adhesive layer is PP, LPPE or HDPE.

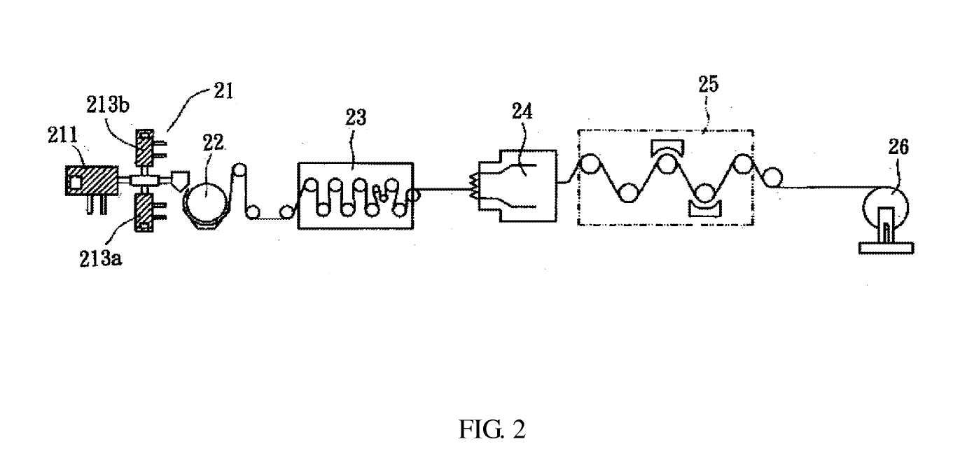

FIG. 2 illustrates a diagram of the process for manufacturing the biaxial oriented polypropylene pearl synthetic paper in accordance with the present invention. The label 21 shown in figure is a twin-screw extruder device of extractable extruder device with side feeding hoppers of the synthetic paper process. The extruder device 21 includes one primary extractable twin-screw extruder 211 with primary feeding hopper and two secondary extractable twin-screw extruder 213a, 213b with side feeding hoppers. The processing temperature is depended on the raw material of resin composite, MFI, crystallinity, production rate and thickness of product.

After the material extrusion molding, to process a cooling process by a cooling shaping roller device 22, which is to cool the 3-layer co-extruded of high temperature, wherein the cooling shaping roller device could adopt a water cooling or air cooling device. The control of cooling temperature in this process is quite important, which promises the success of the steps of following process.

Furthermore, the material base molded by cooling process is fed in longitudinal orientation device 23 to process the longitudinal orientation process, wherein it could set a specific temperature for preheating to soften the material, and then oriented in two steps, high and low speed orientation, to enhance the longitudinal mechanical strength which is then tempered and formed.

Then, the material formed through the longitudinal orientation device is fed into the lateral orientation device 24. The thinner material of formed through the longitudinal orientation device is preheated and softened at a specific temperature (depending on the paper sheet thickness and the production rate), and then laterally oriented and finally tempered and formed, so as to enhance the dimensional stability of pearl synthetic paper.

Thereafter, corona discharge treatment device 25 is used in corona discharge treatment process in the aim to improve the physical character of the surface of the paper sheet and membrane to be used in printing, coating, gluing and lamination etc.. Specific high frequency discharge equipment is used in single or double power processing in order to reach specific moisturizing tension rate.

Lastly, forming was taken by rolling device 26 after the corona discharge treatment, and slitting, cutting, or piece packing synthetic paper product can be formed as needed.

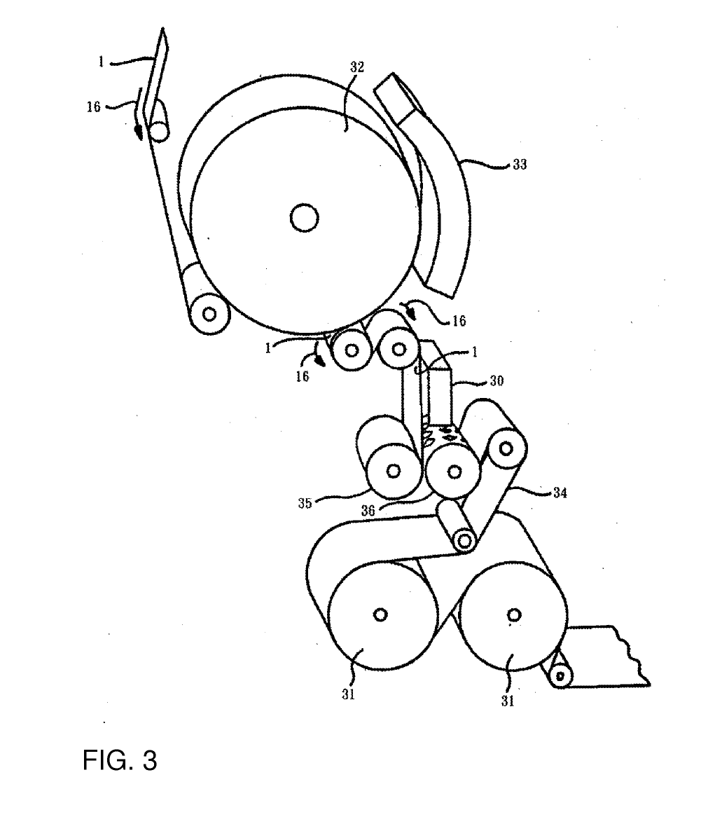

FIG. 3 illustrates a diagram of the device for processing the impressing structure of the present invention.

The device for processing the impressing structure of this present invention is to feed the 3-layer co-extruded biaxial oriented polypropylene pearl synthetic paper 1 as mentioned above through the modified embosser refined by the applicant, which being experimental modified and refined in structure.

According to the present invention, after long term experiment, modification and refining is involved in the hardness of the EPDM rubber, namely the “backs”, should have at least Shore A hardness thickness of 60-90 relatively.

The embossing device of the present invention as shown in FIG. 3, which comprising: a rubber back-up roll 35 having at least Shore A hardness of 60-90; an embossing roll with a designed pattern and a cooling system having a core; a quartz electric heating oven 33 preheated to 65° C. to 160° C. which is on one side of a preheating roll and has a gap between the preheating roll; a infrared heater 30 which is under the quartz electric heating oven; and two adjacent cooling drums 31 with 7° C. The 3-layer co-extruded biaxial oriented polypropylene pearl synthetic paper 1 along heating roll 32, which heated to 65° C. to 160° C. by a quartz electric heating oven 33, to the direction of 16. The synthetic paper 1 is then heat up to no higher than 160° C. (not higher than melting point) by a infrared heater 30 and passing through the embossing roll 36 and the back-up roll 35, which should have at least Shore A hardness of 60-90.

In the impressing process above, cooling water was supplied from a water cooling system (not indicated) to the core of embossing roll 36 to cool its surface.

The engraving of embossing roll in depth should between 0.2 to 1000 μm, range was decided by the product needed so long as it can be formed after passing through the embossing roll 36 and the special hardness back-up roll 35 to form the embossed synthetic paper 34 products and effective cooling.

The speed for the embossed synthetic paper 34 passing through the embossing roll 36 and the special hardness back-up roll 35 and two adjacent cooling drum 31 with 7° C. circulating coiling water is around 15 m/min.

### Embodiment 1

Unlike pearl synthetic paper was used to be embossed on traditional embosser, modified embosser as referred was used. Using patterns on canvas with 5 μm to 15 μm in depth and passing the cooling drum with 7° C. cooling water at the speed of 15 m/min.

### Embodiment 2

Unlike pearl synthetic paper was used to be embossed on traditional embosser, modified embosser as referred was used. Using patterns on rice paper with 2 μm to 10 μm in depth and passing the cooling drum with 7° C. cooling water at the speed of 18 m/min.

### Embodiment 3

Unlike pearl synthetic paper was used to be embossed on traditional embosser, modified embosser as referred was used. Using patterns on shark leather with 0.2 μm to 0.4 μm in depth and passing the cooling drum with 7° C. cooling water at the speed of 15 m/min.

The synthetic paper compressed from papers of embodiment 1 to 3, which using modified embossing device, contributes to the paper feeding of printing equipment.

### DESCRIPTION OF ELEMENTS

1 3-layer co-extruded biaxial oriented polypropylene pearl synthetic paper
11 secondary substrate
12 main substrate
13 secondary substrate
14 embossment or impression
16 orientation directions arrow
21 extruder device
211 primary extractable twin-screw extruder
213a-213b secondary extractable twin-screw extruder
22 cooling shaping roller device
23 longitudinal orientation device
24 lateral orientation device
25 corona discharge treatment device
26 rolling device
30 infrared heater
31 cooling drums
32 heating roll
33 quartz electric heating oven
34 embossed synthetic paper
35 back-up roll
36 embossing roll

1. A method for processing the impression structure of 3-layer co-extruded biaxial oriented polypropylene pearl synthetic paper, which comprising:
1) preheating a pearl synthetic paper with a weight 20 g/m²-210 g/m² to 65° C. to 160° C.;
2) embossing the pearl synthetic paper by passing through a embossing device including a rubber back-up roll having at least Shore A hardness of 60-90 and a embossing roll with a designed pattern;
3) cooling the embossing roll and the back-up roll synchronously during embossing;
cooling the impression by the two adjacent cooling drums, and then the synthetic paper having a certain roughness to facilitate sheet-fed or a substitutional canvas and art paper.

2. The method according to claim 1, wherein the depth of the impression on the synthetic paper is between 0.2-1000 μm.

3. The method according to claim 1, wherein the pearl synthetic paper is fed into the infrared heater for preheating to 65° C. to 160° C., and then the preheated synthetic paper is passed through the embossing roll and the rubber back-up roll having at least Shore A hardness of 60-90 to form the pearl synthetic paper with impression.

4-5. (canceled)
